(19) United States
(12) Patent Application Publication
(10) Pub. No.: US 2026/0271089 A1
(43) Pub. Date: Sep. 10, 2026

(54) METHOD AND APPARATUS FOR COMPENSATING PRACH DECIMATION FILTER FOR DETECTION OF PRACH PREAMBLE IN WIRELESS COMMUNICATION SYSTEM

(71) Applicant: SAMSUNG ELECTRONICS CO., LTD., Suwon-si (KR)

(72) Inventor: Hyuncheol KIM, Suwon-si (KR)

(73) Assignee: SAMSUNG ELECTRONICS CO., LTD., Suwon-si (KR)

(21) Appl. No.: 19/559,054

(22) Filed: Mar. 6, 2026

Related U.S. Application Data
(63) Continuation of application No. PCT/KR2026/003587, filed on Mar. 5, 2026.

(30) Foreign Application Priority Data
Mar. 7, 2025 (KR) 10-2025-0030045

(51) Int. Cl. H04W 74/0833; H04L 27/26; H04W 72/0446

(52) U.S. Cl. CPC H04W 74/0833; H04L 27/265; H04W 72/0446

(57) ABSTRACT

A method performed by a base station in a wireless communication system, includes receiving, from a user equipment (UE), a physical random access channel (PRACH) preamble, detecting the received PRACH preamble by identifying a first frequency response of a PRACH decimation filter in a PRACH detector, dividing subcarriers for receiving the PRACH preamble into subcarrier segments, obtaining a representative weight for each subcarrier segment of the subcarrier segments, applying linear interpolation to representative weights of adjacent subcarrier segments from among the subcarrier segments, compensating for distortion in the first frequency response of each segment of the subcarrier segments by applying, to a first subcarrier signal of the PRACH preamble, a weight to which the linear interpolation has been applied as a compensation weight, and outputting a second subcarrier signal corresponding to a second frequency response in which the distortion has been compensated.

### CROSS-REFERENCE TO RELATED APPLICATIONS

This application is a continuation of International Application No. PCT/KR2026/003587 designating the United States, filed on Mar. 5, 2026, which claims priority to Korean Patent Application No. 10-2025-0030045, filed on Mar. 7, 2025, in the Korean Ministry of Intellectual Property, the disclosures of which are incorporated by reference herein in their entireties

### BACKGROUND

### 1. Field

The present disclosure relates generally communication systems, and more particularly, to a method and a device of a base station for receiving a physical random access channel (PRACH) preamble from a user equipment (UE) in a wireless communication system.

### 2. Description Of Related Art

Fifth generation (5G) systems (e.g., a new radio (NR) system) may have been developed and/or commercialized in order to attempt to meet increasing demands for wireless data traffic following adoption of fourth generation (4G) system (e.g., long-term evolution (LTE) systems). For example, 5G systems may be implemented in a millimeter wave (mmWave) band. However, to relieve possible path loss of signals and/or to potentially increase the transmission distance of signals in the mmWave band, techniques such as, but not limited to, beamforming, massive multiple-input and multiple-output (massive MIMO), full dimensional MIMO (FD-MIMO), array antennas, analog beamforming, large scale antennas, or the like may be under discussion for implementation and/or deployment of 5G systems.

In an orthogonal frequency division multiplexing (OFDM)-based wireless communication system, such as, but not limited to, an LTE system, an NR system, or a new radio-unlicensed (NR-U) system for communication in an unlicensed band, a user equipment (UE) may perform random access by using a physical random access channel (PRACH) preamble transmitted through a PRACH. In the NR system, a PRACH may be and/or may include a physical channel transmitting a PRACH preamble for initial access to a base station (hereinafter referred to as a gNodeB (gNB)). A UE may perform initial access by performing a random access procedure with a base station by using a PRACH, and may obtain uplink synchronization with the base station.

A PRACH preamble may have a specified structure in frequency and time domains.

FIG. 1 illustrates an example of a PRACH preamble.

Referring to FIG. 1, the PRACH preamble may include a cyclic prefix (CP) 110 and a preamble body 120 including a plurality of preamble symbols. The CP 110 may be configured to interference in a multipath environment, and each symbol of the plurality of preamble symbols in the preamble body 120 may use an OFDM symbol. FIG. 1 shows a preamble body including S symbols, each of the symbols having a symbol length of N, where S and N are positive integers greater than zero (0).

PRACH preambles may be divided into a long preamble format or a short preamble format. The long preamble format may use a frequency range 1 (FR1) of 6 gigahertz (GHz) or lower, may have a long guard interval, and may be used in a subcarrier spacing of 1.25 kilohertz (kHz) and/or 5 kHz. The short preamble format may use a FR1 of 6 GHz or less and/or a second frequency range (FR2) of a mmWave band greater than 6 GHz, may be used in a subcarrier spacing of 15 kHz or greater, according to a used frequency range (e.g., FR1 or FR2), a subcarrier spacing (SCS), a preamble length, and/or a guard interval.

The PRACH preamble of FIG. 1 may be transmitted from a UE to a base station, and the base station may generally use a fast Fourier transform (FFT) and/or inverse FFT (IFFT)-based PRACH detector to receive the PRACH preamble. The PRACH detector may use a PRACH decimation filter as a filter for extracting a PRACH-band signal. However, the PRACH decimation filter may cause distortion, and consequently, a method for preventing and/or reducing the distortion arising in the PRACH decimation filter may be needed.

### SUMMARY

Example embodiments of the present disclosure provide an efficient method and device for compensating a PRACH decimation filter for detecting a PRACH preamble in a wireless communication system.

According to an embodiment of the disclosure, a method performed by a base station receiving a PRACH preamble from a UE in a wireless communication system may comprise receiving, from a user equipment (UE), a physical random access channel (PRACH) preamble. The method may comprise detecting the received PRACH preamble by identifying a first frequency response of a PRACH decimation filter in a PRACH detector. The method may comprise dividing subcarriers for receiving the PRACH preamble into subcarrier segments. The method may comprise obtaining a representative weight for each subcarrier segment of the subcarrier segments. The method may comprise applying linear interpolation to representative weights of adjacent subcarrier segments from among the subcarrier segments. The method may comprise compensating for distortion in the first frequency response of each segment of the subcarrier segments by applying, to a first subcarrier signal of the PRACH preamble, a weight to which the linear interpolation has been applied as a compensation weight. The method may comprise outputting a second subcarrier signal corresponding to a second frequency response in which the distortion has been compensated.

According to an embodiment of the disclosure, in the method, the applying of the compensation weight may comprise performing a fast Fourier transform (FFT) on a time-domain signal of the PRACH preamble to obtain a frequency-domain signal of the PRACH preamble, and applying the compensation weight to a subcarrier signal of the frequency-domain signal of the PRACH preamble.

According to an embodiment of the disclosure, in the method, the obtaining of the representative weight may comprise calculating the representative weight for each subcarrier segment, based on a segment size of the subcarrier segments, a segment number of the subcarrier segments, and a sequence length of the PRACH preamble.

According to an embodiment of the disclosure, in the method, the representative weights may comprise a first representative weight and a second representative weight having adjacent indexes, wherein the method further may comprise obtaining the compensation weight by performing a linear interpolation operation based on the first representative weight and the second representative weight.

According to an embodiment of the disclosure, in the method, the representative weights may comprise a first representative weight and a second representative weight, wherein a first index of the first representative weight may comprise a value of a second index of the second representative weight plus one (1), wherein the method may further comprise obtaining a first value by dividing a value of the first representative weight minus the second representative weight by the segment size of the subcarrier segments, determining an index of the compensation weight based on the sequence length of the PRACH preamble, obtaining a second value by multiplying the first value by a ratio value based on the index of the compensation weight, and obtaining the compensation weight by adding the second representative weight to the second value, and wherein the applying of the linear interpolation may comprise applying the linear interpolation to the representative weights of the adjacent subcarrier segments from among the subcarrier segments based on the first representative weight and the second representative weight.

According to an embodiment of the disclosure, a base station in a wireless communication system, the base station may comprise a transceiver, one or more processors comprising processing circuitry, and memory storing instructions, wherein the instructions, when executed by the one or more processors individually or collectively, may cause the base station to receive, from a UE through the transceiver, a signal comprising a PRACH preamble. The instructions, when executed by the one or more processors individually or collectively, may cause the base station to detect the received PRACH preamble by identifying a first frequency response of a PRACH decimation filter in a PRACH detector. The instructions, when executed by the one or more processors individually or collectively, may cause the base station to divide subcarriers for receiving the PRACH preamble into subcarrier segments. The instructions, when executed by the one or more processors individually or collectively, may cause the base station to obtain a representative weight for each subcarrier segment of the subcarrier segments. The instructions, when executed by the one or more processors individually or collectively, may cause the base station to apply linear interpolation to representative weights of adjacent subcarrier segments from among the subcarrier segments. The instructions, when executed by the one or more processors individually or collectively, may cause the base station to compensate for distortion in the first frequency response of each segment of the subcarrier segments by applying, to a first subcarrier signal of the PRACH preamble, a weight to which the linear interpolation has been applied as a compensation weight. The instructions, when executed by the one or more processors individually or collectively, may cause the base station to output a second subcarrier signal corresponding to a second frequency response in which the distortion has been compensated.

According to an embodiment of the disclosure, a method performed by a base station receiving a PRACH preamble from a UE in a wireless communication system may comprise receiving, from a UE, a PRACH preamble. The method may comprise detecting the received PRACH preamble by identifying a first frequency response of a PRACH decimation filter in a PRACH detector. The method may comprise dividing subcarriers for receiving the PRACH preamble into subcarrier segments. The method may comprise obtaining an average weight for each segment of the subcarrier segments as a representative weight for each subcarrier segment. The method may comprise compensating for distortion in the first frequency response of each segment of the subcarrier segments by applying, to a first subcarrier signal of the PRACH preamble, the representative weight as a compensation weight. The method may comprise outputting a second subcarrier signal corresponding to a second frequency response in which the distortion has been compensated.

According to an embodiment of the disclosure, in the method, the applying of the compensation weight may comprise performing a fast FFT on a time-domain signal of the PRACH preamble to obtain a frequency-domain signal of the PRACH preamble, and applying the compensation weight to a subcarrier signal of the frequency-domain signal of the PRACH preamble.

According to an embodiment of the disclosure, the method may further comprise obtaining the compensation weight by dividing a first magnitude of the first frequency response by a second magnitude of the second frequency response, wherein the second frequency response corresponds to a target frequency response for compensating the distortion arising from the first frequency response.

According to an embodiment of the disclosure, in the method, the obtaining of the representative weight may comprise calculating the average weight for each subcarrier segment, based on a segment size of the subcarrier segments, a segment number of the subcarrier segments, and a sequence length of the PRACH preamble.

According to an embodiment of the disclosure, a base station in a wireless communication system, the base station may comprise a transceiver, one or more processors comprising processing circuitry, and memory storing instructions, wherein the instructions, when executed by the one or more processors individually or collectively, may cause the base station to receive, from a UE through the transceiver, a signal comprising a PRACH preamble. The instructions, when executed by the one or more processors individually or collectively, may cause the base station to detect the received PRACH preamble by identifying a first frequency response of a PRACH decimation filter in a PRACH detector. The instructions, when executed by the one or more processors individually or collectively, may cause the base station to divide subcarriers for receiving the PRACH preamble into subcarrier segments. The instructions, when executed by the one or more processors individually or collectively, may cause the base station to obtain an average weight for each segment of the subcarrier segments as a representative weight for each subcarrier segment. The instructions, when executed by the one or more processors individually or collectively, may cause the base station to compensate for distortion in the first frequency response of each segment of the subcarrier segments by applying to a first subcarrier signal of the PRACH preamble, the representative weight for each subcarrier segment as a compensation weight. The instructions, when executed by the one or more processors individually or collectively, may cause the base station to output a second subcarrier signal corresponding to a second frequency response in which the distortion has been compensated.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates an example of a PRACH preamble, according to an embodiment of the present disclosure;

FIG. 2 illustrates an example of a configuration of a reception device of a base station for detecting a PRACH preamble in a wireless communication system, according to an embodiment of the present disclosure;

FIG. 3 illustrates an example of a configuration of a PRACH decimation filter included in a PRACH detector of a base station in a wireless communication system, according to an embodiment of the present disclosure;

FIG. 4 illustrates an example of a configuration of a reception device of a base station for detecting a PRACH preamble in a wireless communication system, according to an embodiment of the present disclosure;

FIG. 5 illustrates an example of a configuration of a PRACH filter compensator, according to an embodiment of the present disclosure;

FIG. 6 illustrates an example of a frequency response characteristic of a PRACH decimation filter for PRACH preamble format 0 in a wireless communication system, according to an embodiment of the present disclosure;

FIG. 7 illustrates an example of a frequency response characteristic of a PRACH decimation filter for PRACH preamble format 0 in a wireless communication system, according to an embodiment of the present disclosure;

FIG. 8 illustrates an example of SNR loss reduced according to the number of subcarrier segments in a PRACH filter compensator in a wireless communication system, according to an embodiment of the present disclosure;

FIG. 9 illustrates an example of a compensated frequency response characteristic of a PRACH decimation filter when a PRACH filter compensator is used in a wireless communication system, according to an embodiment of the present disclosure;

FIG. 10 illustrates an example of SNR loss reduced according to the number of subcarrier segments in a PRACH filter compensator in a wireless communication system, according to an embodiment of the present disclosure;

FIG. 11 illustrates an example of a method for compensating distortion in a frequency response of a PRACH decimation filter for detecting a PRACH preamble in a wireless communication system, according to an embodiment of the present disclosure;

FIG. 12 illustrates an example of a method for compensating distortion in a frequency response of a PRACH decimation filter for detecting a PRACH preamble in a wireless communication system, according to an embodiment of the present disclosure; and

FIG. 13 illustrates an example of a structure of a communication device in a wireless communication system, according to an embodiment of the present disclosure.

### DETAILED DESCRIPTION

Hereinafter, the present disclosure is described in conjunction with the accompanying drawings. In describing the present disclosure below, a detailed description of known functions or configurations may be omitted when the description may make the subject matter of the present disclosure unnecessarily unclear. The terms described below are defined in consideration of the functions in the present disclosure, and may be different according to users, intentions of the users, and/or customs. Therefore, the definitions of the terms should be made based on the contents throughout the present disclosure.

The advantages and features of the disclosure and ways to achieve them are to be apparent by making reference to embodiments as described below in conjunction with the accompanying drawings. However, the present disclosure is not limited to the embodiments set forth below, but may be implemented in various different forms. The following embodiments are provided only to disclose the present disclosure and inform those skilled in the art of the scope of the disclosure, and the present disclosure is defined only by the scope of the appended claims.

With regard to the description of the drawings, similar reference numerals may be used to refer to similar or related elements. It is to be understood that a singular form of a noun corresponding to an item may include one or more of the things, unless the relevant context clearly indicates otherwise.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

Herein, it is to be understood that each block of the flowchart illustrations, and combinations of blocks in the flowchart illustrations, may be implemented by computer program instructions. It is to be understood that the specific order or hierarchy of blocks in the processes/flowcharts disclosed are an illustration of exemplary approaches.

Furthermore, each block in the flowchart illustrations may represent a module, segment, or portion of code, which may include one or more executable instructions for implementing the specified logical functions. It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

As used in embodiments of the disclosure, the term “unit” may refer to a software element or a hardware element, such as, but not limited to, a field programmable gate array (FPGA), an application specific integrated circuit (ASIC), or the like, and the “unit” may perform certain functions. However, the “unit” may not always refer to software or hardware. The “unit” may be constructed either to be stored in an addressable storage medium or to execute one or more processors. Therefore, the “unit” may include, for example, software elements, object-oriented software elements, class elements or task elements, processes, functions, properties, procedures, sub-routines, segments of a program code, drivers, firmware, micro-codes, circuits, data, database, data structures, tables, arrays, parameters, or the like. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” may include one or more processors that may be configured to execute instructions individually and/or collectively.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

As used herein, a base station (BS) may refer to a network entity that may perform resource allocation to a user equipment (UE) and communicate with the UE through a wireless network, and may be at least one of an eNode B (eNB), a Node B (NB), a gNode B (gNB), a radio access network (RAN), an access network (AN), a RAN node, an integrated access/backhaul (IAB) node, a wireless access unit, a base station controller, a node on a network, a transmission reception point (TRP), or the like. A user equipment (UE) may be and/or may include at least one of a terminal, a mobile station (MS), a cellular phone, a smartphone, a computer, or a multimedia system capable of performing a communication function.

In an orthogonal frequency division multiplexing (OFDM)-based system, such as, but not limited to, a fifth generation (5G) system, a PRACH preamble may use a subcarrier spacing (SCS) equal to or smaller than an SCS used by other uplink (UL) channels and may allocate a relatively small number of resource blocks (RBs) to support wide cell coverage. For example, in an LTE system where a number of UL RBs may be equal to 100 RBs and an UL SCS may be set to 15 kilohertz (kHz), a PRACH format 0 (e.g., L=839 and number of preamble symbols=1) may use a PRACH SCS of 1.25 kHz and six (6) RBs. The PRACH SCS of 1.25 kHz may have a period of 0.8 milliseconds (ms), and may have a preamble symbol length of 24,576 Tₛ based on a sampling time Tₛ of 1/30.72 M[sec]. For a PRACH reception unit of a base station, it may be advantageous to extract and/or process only a signal of a PRACH RB among all UL RBs in view of complexity. Consequently, a PRACH detector that detects a PRACH preamble in the base station may include a frequency detector and a PRACH decimation filter, and the base station may extract a signal in a PRACH band through the PRACH detector.

Hereinafter, various embodiments of the present disclosure are described with reference to the accompanying drawings.

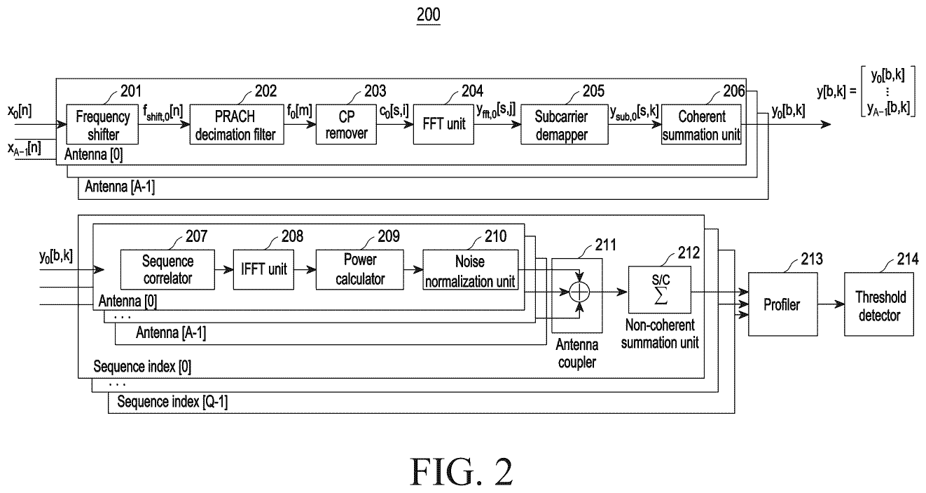

FIG. 2 illustrates an example of a configuration of a reception device of a base station for detecting a PRACH preamble in a wireless communication system to which the disclosure is applied. The reception device 200 of FIG. 2 may include a PRACH detector, and the PRACH detector may use an FFT/IFFT-based PRACH detector.

Referring to FIG. 2, the reception device 200 of the base station configured to receive a PRACH preamble may include a frequency shifter 201, a PRACH decimation filter 202, a CP remover 203, an FFT unit 204, a subcarrier demapper 205, a coherent summation unit 206, a sequence correlator 207, an IFFT unit 208, a power calculator 209, a noise normalization unit 210, an antenna coupler 211, a non-coherent summation unit 212, a profiler 213, and a threshold detector 214. In the configuration of FIG. 2, components directly related to distortion arising when the base station receives a PRACH preamble may include the frequency shifter 201 and the PRACH decimation filter 202.

Referring to FIG. 2, the frequency shifter 201 may perform a frequency shift so that a center subcarrier of an RB in which a PRACH exists in a received signal x[n]=[x₀[n], . . . , x_{A-1}[n]]^{T} is positioned at a DC subcarrier. The frequency shifter 201 may perform a frequency shift to a PRACH occasion for detecting a PRACH preamble in a frequency domain. That is, a plurality of uplink channels, such as, but not limited to, a PRACH in which a PRACH preamble is received, a physical uplink control channel (PUCCH) in which uplink control information is received, and a physical uplink shared channel (PUSCH) in which uplink data is received, may exist in the entire bandwidth in which the base station may receive an uplink signal from a UE, and the base station may need to perform a frequency shift to a center subcarrier of the PRACH in which the PRACH preamble may be received in the entire bandwidth.

The PRACH decimation filter 202 may perform functions of low-pass filtering and downsampling to allow a signal of a PRACH band to pass through to subject the frequency-shifted received signal to low-pass filtering, and performs decimation by R to extract a PRACH signal f[m]=[f₀[m], . . . , f_{A-1}[m]]^{T}. Here, m may represent a sample index after the decimation, and R may represent a decimation factor. (e.g. an example use of the decimation factor R may refer to [Equation 3] below) The decimation factor may be a value obtained by dividing a sampling rate for a reception band according to SCS in reception of the PRACH preamble by the FFT size of the FFT unit 204.

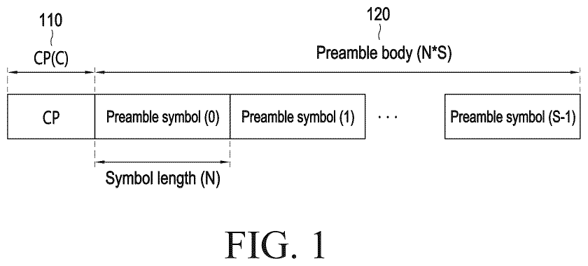

The CP remover 203 removes a CP from the signal extracted by the PRACH decimation filter 202 and outputs the signal. The output signal of the CP remover 203 is a symbol-unit signal c[s, i]=[c₀[s, i], . . . , c_{A-1}[s, i]]^{T} using a preamble body described in FIG. 1. As used herein, s may represent a symbol index (e.g., s may range from zero (0) to S −1 (e.g., s=0 to S−1), where S is the number of symbols and is a positive integer greater than zero (0)), i may represent a sample index (e.g., i may range from zero (0) to N_{FFT}−1 (e.g., i=0 to N_{FFT}−1), where N_{FFT} is the size of the FFT and is a positive integer greater than zero (0)) in a symbol, A may represent the number of antennas in the reception device of the base station and is a positive integer greater than zero (0), and T may represent the transpose of a matrix or a vector. The FFT unit 204 performs symbol-unit FFT of converting the time-domain signal input from the CP remover 203 into a frequency-domain signal y_{fft}[s, j]=[y_{fft,0}[s,j],], y_{fft,A-1}[s, j]i^{T}. As used herein, j may represent a subcarrier index, where j=0~N_{FFT}−1. The subcarrier demapper 205 may receive the frequency-domain signal from the FFT unit 204 and may output a subcarrier signal y_{sub}[s, k]=[y_{sub,0}[s, k], . . . , y_{sub,A-1}[s, k]]^{T} allocated for the preamble. As used herein, k may range from zero (0) to L_{RA}−1 (e.g., k 0~L_{RA}−1), where L_{RA} is the length of a preamble sequence used in the frequency domain, and may be less than or equal to the FFT size N_{FFT} of the FFT unit 204.

The coherent summation unit 206 may receive the subcarrier signal from the subcarrier demapper 205, and may summate as many subcarrier signals as C symbols to output S/C (where S is the number of symbols of the preamble body) symbol signals y[b, k]=[y₀[b, k], . . . ,y_{A-1}[b, k]]^{T}. As used herein, b may represent a symbol index after coherent summation, and C may be selected and used from values that make S/C an integer. The sequence correlator 207 may multiply the symbol signal y[b, k] input from the coherent summation unit 206 by a complex conjugate of the preamble sequence to calculate the correlation of the symbol signal, and output a result. In some embodiments, the preamble sequence may employ, for example, a Zadoff-Chu sequence. However, embodiments of the present disclosure are not limited in this regard.

The IFFT unit 208 may perform N_{IFFT}-size IFFT of converting the frequency-domain signal input from the sequence correlator 207 to a time-domain signal. The power calculator 209 may calculate the power of each sample by performing a squared magnitude of a complex number on the time-domain signal input from the IFFT unit 208. The noise normalization unit 210 may estimate a noise value of each sample input from the power calculator 209, and may perform normalization on each sample with the estimated noise value.

Continuing to refer to FIG. 2, signal processing for reception of the PRACH preamble in the components 201 to 210 may be performed for each antenna of a plurality of antennas (e.g., a first antenna Antenna[0], to an (A−1)-th antenna Antenna[A−1]) in the reception device of the base station. As illustrated in FIG. 2, the number of antennas of the base station may be set as A, where A is a positive integer greater than zero (0). The antenna coupler 211 may summate power calculated for each antenna to output a summated power value. The non-coherent summation unit 212 may receive the summated power value from the antenna coupler 211 that processes S/C symbols (e.g., N_{IFFT} samples per symbol), where S is the number of symbols in the preamble body and C is the number of symbols summated in the coherent summation unit 206, may summate as many power values as the S/C symbols, and may convert the power values to output N_{IFFT} power values for each preamble sequence. The foregoing operations of the components 207 to 212 may be repeatedly performed Q times, which is the number of preamble sequences (e.g., a first sequence index [0] to a (Q−1)-th sequence index [Q−1]). The profiler 213 may calculate representative power (e.g., maximum power) and a delay (e.g., a sample index having the maximum power) for each preamble index by using the N_{IFFT} power values for each preamble sequence. As used herein, the delay may refer to a delay occurring in the channel. In an IFFT signal, a delay may appear as a sample index, and a sample index may have a specific time unit. That is, a delay occurring in a channel may be calculated based on a selected sample index. As used herein, the preamble index may correspond to a cyclic shift zone in the preamble sequence. According to various telecommunication standards, such as but not limited to 4G LTE standards, 5G NR standards, or the like, the cyclic shift zone may enable, for example, for a PRACH of a length of L_{RA}, measurement of a circular shift (delay) of 0~L_{RA}−1 in a unit of a maximum PRACH sequence. According to the such telecommunication standards, the size of the cyclic shift zone may be defined as N_{CS}, and the cyclic shift zone may be divided into [L_{RA}/N_{CS}] regions for use, such as 0~N_{CS}−1 for preamble index 0 region and N_{CS}~2N_{CS}−1N_{CS}~2N_{CS}−1 for a preamble index 1 region.

The threshold detector 214 may compare the representative power for each preamble index with a predetermined threshold value to determine whether the PRACH preamble is detected. For example, the threshold detector 214 may determine that the PRACH preamble has been detected when the representative power is greater than the threshold value, and may determine that the PRACH preamble has not been detected when the representative power is less than or equal to the threshold value.

In an embodiment, the PRACH decimation filter 202 used in the reception device of the base station as illustrated in FIG. 2, which may be used in a reception device of a base station, may need to support various values of the decimation factor and may need to have a relatively low complexity, when compared to related wireless communication systems.

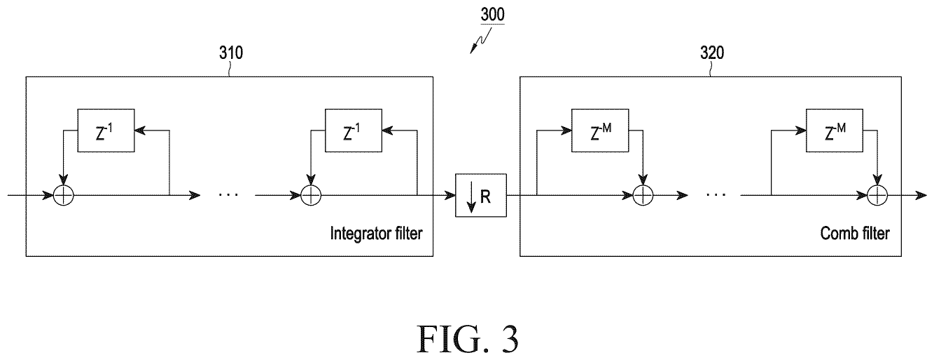

FIG. 3 illustrates an example of a configuration of a PRACH decimation filter included in a PRACH detector of a base station in a wireless communication system to which the present disclosure is applied.

Referring to FIG. 3, the PRACH decimation filter 202 may use a cascaded integrator comb (CIC) decimation filter 300. The CIC decimation filter 300 may include an integrator filter 310 in which N single integrators are concatenated and a comb filter 320 in which N single comb stages are concatenated, where N is a positive integer greater than zero (0). The CIC decimation filter 300 may have a frequency response characteristic of, for example, a half-moon shape, and/or a droop phenomenon in which an edge of a frequency response in a PRACH band passing through the CIC decimation filter 300 droops (e.g., where the frequency response characteristic is gradually reduced) may arise. The droop phenomenon may be at least one of causes that may induce distortion in reception of a PRACH preamble. The droop phenomenon may be intensified in proportion to an increase in the value of a decimation factor. In addition, when the droop phenomenon is intensified, signal-to-noise ratio (SNR) loss may arise in the PRACH preamble.

To reduce, remove, and/or compensate for the distortion caused by the droop phenomenon in the reception of the PRACH preamble, the decimation factor may be reduced. For example, when the value of the decimation factor applied to the PRACH decimation filter is reduced by ½ (e.g., half), a guard band may be increased to alleviate the droop phenomenon in the reception of the PRACH preamble. However, as the value of the decimation factor increases, the FFT size of the FFT unit 204 may be doubled, thus potentially increasing FFT complexity. Additionally or alternatively, when a finite impulse response (FIR)-type decimation filter having a relatively flat frequency response characteristic is used in a communication environment with a small guard band, a complex baseband filter having a large number of taps may need to be used.

In an OFDM-based wireless communication system to which the present disclosure is applied, the length of a preamble sequence for a PRACH preamble may be diversified. The length of a preamble sequence currently used in the wireless communication system may be at least one of 139, 839, 571, or 1151. However, various lengths of a preamble sequence may be added in the future in a change to 5G NR telecommunication standards and/or subsequent telecommunication standards (e.g., sixth generation (6G)). When a PRACH preamble sequence of a length close to (e.g., approximately, within a certain threshold of) 2ⁿ (e.g., 479) is used, a related technology may need to use an FFT of a size of 2⁽ⁿ⁺¹⁾, thereby potentially causing a significant increase in FFT complexity.

The present disclosure proposes a method that enables a reception device of a base station using a PRACH decimation filter to use an FFT of a size of 2ⁿ (e.g., a relatively small FFT size) close to the length of a PRACH preamble sequence even when the PRACH preamble sequence of a length close to 2ⁿ is used. Since FFT complexity may decrease as FFT size decreases, it may be important to configure a reception device of a base station to use an FFT of a size of 2ⁿ close to the length of a PRACH preamble sequence. However, when the base station performs decimation by using a PRACH decimation filter (e.g., a CIC decimation filter), distortion due to a droop phenomenon may arise in a PRACH band, and the distortion due to the droop phenomenon may be intensified as the value of a decimation factor increases (e.g., as a guard band becomes smaller). The distortion in the PRACH band may be seen as SNR loss when detecting a PRACH preamble. According to the present disclosure, distortion in a PRACH band due to use of a PRACH decimation filter may be reduced in a communication environment in which an FFT of a size of 2ⁿ close to the length of a PRACH preamble sequence is used, and a decrease in the distortion in the PRACH band may result in a decrease in SNR loss.

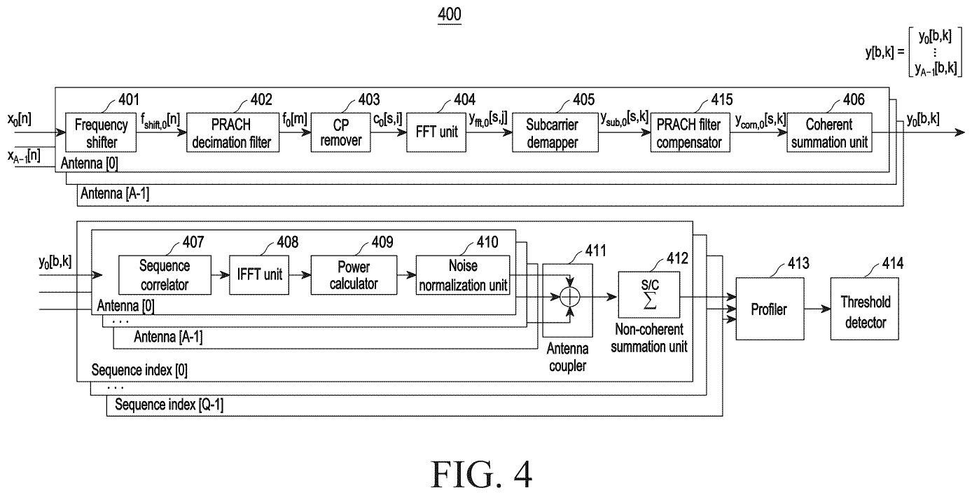

FIG. 4 illustrates an example of a configuration of a reception device of a base station for detecting a PRACH preamble in a wireless communication system according to an embodiment of the disclosure. The reception device 400 of FIG. 4 may include a PRACH detector and a PRACH filter compensator, and the PRACH detector may include a frequency detector and a PRACH decimation filter and may use an FFT/IFFT-based PRACH detector.

The reception device 400 of FIG. 4 may include and/or may be similar in many respects to the reception device 200 described above with reference to FIG. 2, and may include additional features not mentioned above. Consequently, repeated descriptions of the reception device 400 described above with reference to FIG. 2 may be omitted for the sake of brevity.

Referring to FIG. 4, the reception device 400 of the base station configured to receive a PRACH preamble may include a frequency shifter 401, a PRACH decimation filter 402, a CP remover 403, an FFT unit 404, a subcarrier demapper 405, a coherent summation unit 406, a sequence correlator 407, an IFFT unit 408, a power calculator 409, a noise normalization unit 210, an antenna coupler 411, a non-coherent summation unit 412, a profiler 413, and a threshold detector 414. As shown in FIG. 4, components related to distortion related to a droop phenomenon arising when the base station receives a PRACH preamble may include the frequency shifter 401 and the PRACH decimation filter 402.

The PRACH filter compensator 415 may be included in an output path of the PRACH detector in order to reduce, remove and/or compensate for distortion related to a droop phenomenon. The PRACH filter compensator 415 is further described below.

Referring to FIG. 4, the frequency shifter 401 may perform a frequency shift so that a center subcarrier of an RB in which a PRACH exists in a received signal x[n]=[x₀[n], . . . , x_{A-1}[n]]^{T} is positioned at a DC subcarrier. The frequency shifter 201 may perform a frequency shift to a PRACH occasion for detecting a PRACH preamble in a frequency domain. That is, a plurality of uplink channels, such as, but not limited to, a PRACH in which a PRACH preamble is received, a PUCCH in which uplink control information is received, and a PUSCH in which uplink data is received, may exist in the entire bandwidth in which the base station may receive an uplink signal from a UE, and the base station may need to perform a frequency shift to a center subcarrier of the PRACH in which the PRACH preamble may be received in the entire bandwidth.

The PRACH decimation filter 402 performs functions of low-pass filtering and downsampling to allow a signal of a PRACH band to pass through to subject the frequency-shifted received signal to low-pass filtering, and performs decimation by R to extract a PRACH signal f[m]=[f₀[m], . . . , f_{A-1}[m]]^{T}. As used herein, m may represent a sample index after the decimation, and R may represent a decimation factor (e.g. an example use of the decimation factor R may refer to [Equation 3] below). The decimation factor may be a value obtained by dividing a sampling rate for a reception band according to a SCS in reception of the PRACH preamble by the FFT size of the FFT unit 404. In an embodiment, the length of a PRACH preamble sequence may be close to 2ⁿ, and the FFT size may be 2ⁿ.

The CP remover 403 may remove a CP from the signal extracted by the PRACH decimation filter 402 and outputs the signal. The output signal of the CP remover 403 may be a symbol-unit signal c[s, i]=[c₀[s, i], . . . , c_{A-1}[s, i]]^{T} using a preamble body described in FIG. 1. As used herein, s may represent a symbol index (e.g., s may range from zero (0) to S −1 (e.g., s=0 to S−1), where S is the number of symbols and is a positive integer greater than zero (0)), i may represent a sample index (e.g., i may range from zero (0) to N_{FFT}−1 (e.g., i=0 to N_{FFT}−1), where N_{FFT} is the size of the FFT and is a positive integer greater than zero (0)) in a symbol, A may represent the number of antennas in the reception device of the base station and is a positive integer greater than zero (0), and T may represent the transpose of a matrix or vector. The FFT unit 404 performs symbol-unit FFT of converting the time-domain signal input from the CP remover 403 into a frequency-domain signal y_{fft}[s, j]=[y_{fft,0}[s, j], j], y_{fft,A-1}[s, j]]^{T}. As used herein, j may represent a subcarrier index, where j=0, . . . , N_{FFT}− 1. The subcarrier demapper 405 may receive the frequency-domain signal from the FFT unit 404 and may output a subcarrier signal y_{sub [s, k]=[y}_{sub,0}[S, k], . . . , y_{sub,A-1}[s, k]]^{T} allocated for the preamble. As used herein, k may range from zero (0) to L_{RA}−1 (e.g., k=0~L−1), where L_{RA} is the length of a preamble sequence used in the frequency domain, and may be less than or equal to the FFT size N_{FFT} of the FFT unit 404.

As shown in FIG. 4, the PRACH filter compensator 415 may apply a compensation weight calculated, obtained, and/or estimated per subcarrier to the subcarrier signal input from the subcarrier demapper 405 so that a current frequency response (e.g., a first frequency response) of the PRACH decimation filter 402 may approximate a target frequency response (e.g., a second frequency response) in order to reduce, remove, and/or compensate for a droop phenomenon in the current frequency response, thereby outputting a signal corresponding to the target frequency response in which droop in the current frequency response of the PRACH decimation filter 402 on an edge (gradual decrease to the edge) is mitigated and/or compensated.

The coherent summation unit 406 may receive the subcarrier signal with a compensated frequency response characteristic from the PRACH filter compensator 415, and may summate as many subcarrier signals as C symbols to output S/C (where S is the number of symbols of the preamble body) symbol signals y[b, k]=[y₀[b, k], . . . , y_{A-1}[b, k]]^{T}. As used herein, b may represent a symbol index after coherent summation, and C may be selected and used from values that make S/C an integer. The sequence correlator 407 may multiply the symbol signal y[b, k] input from the coherent summation unit 406 by a complex conjugate of the preamble sequence to calculate the correlation of the symbol signal, and outputs a result. The preamble sequence may employ, for example, a Zadoff-Chu sequence. However, embodiments of the present disclosure are not limited thereto.

Although the PRACH filter compensator 415 of FIG. 4 is illustrated as being disposed in an input path of the coherent summation unit 406, embodiments of the present disclosure are not limited thereto. For example, in an embodiment, the PRACH filter compensator 415 may be disposed in an output path of the coherent summation unit 406.

The IFFT unit 408 may perform N_{IFFT}-size IFFT of converting the frequency-domain signal input from the sequence correlator 407 to a time-domain signal. The power calculator 409 may calculate the power of each sample by performing a squared magnitude of a complex number on the time-domain signal input from the IFFT unit 408. The noise normalization unit 410 may estimate a noise value of each sample input from the power calculator 409, and may perform normalization on each sample with the estimated noise value.

Continuing to refer to FIG. 4, signal processing for reception of the PRACH preamble in a signal path including the PRACH filter compensator 415 and the components 401 to 410 may be performed for each antenna of a plurality of antennas (e.g., a first antenna Antenna[0], to an (A−1)-th antenna Antenna[A−1]) in the reception device 400 of the base station. As shown in FIG. 4, the number of antennas of the base station may be set as A, where A is a positive integer greater than zero (0). The antenna coupler 411 may summate power calculated for each antenna to output a summated power value. The non-coherent summation unit 412 receives the summated power value from the antenna coupler 411 that processes S/C symbols (e.g., N_{IFFT} samples per symbol) (where S is the number of symbols in the preamble body and C is the number of symbols summated in the coherent summation unit 406), may summate as many power values as the S/C symbols, and may convert the power values to output N_{IFFT} power values for each preamble sequence. The foregoing operations of the components 407 to 412 may be repeatedly performed Q times, which may be the number of preamble sequences (e.g., a first sequence index [0] to a (Q−1)-th sequence index [Q−1]). The profiler 413 may calculate representative power (e.g., maximum power) and a delay (e.g., a sample index having the maximum power) for each preamble index by using the N_{IFFT} power values for each preamble sequence. As used herein, the preamble index may correspond to a cyclic shift zone in the preamble sequence. The threshold detector 414 may compare the representative power for each preamble index with a predetermined threshold value to determine whether the PRACH preamble is detected. For example, the threshold detector 214 may determine that the PRACH preamble has been detected when the representative power is greater than the threshold value, and may determine that the PRACH preamble has not been detected when the representative power is less than or equal to the threshold value.

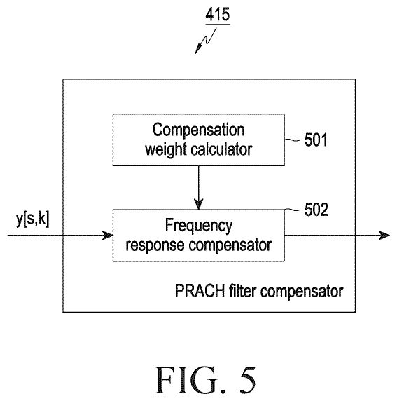

FIG. 5 illustrates an example of a configuration of a PRACH filter compensator according to an embodiment of the disclosure, which illustrates a configuration of the PRACH filter compensator 415 of FIG. 4. Referring to FIG. 5, the PRACH filter compensator 415 may include a compensation weight calculator 501 and a frequency response corrector 502.

The compensation weight calculator 501 may output a compensation weight that is calculated/obtained to enable a current frequency response (e.g., a first frequency response) of the PRACH decimation filter 402 to approximate a preset target frequency response (e.g., a second frequency response). The compensation weight may be calculated to mitigate and/or compensate for a droop phenomenon in which an edge of the current frequency response of the PRACH decimation filter 402 may droop (e.g., the edge may gradually be reduced). The frequency response corrector 502 may apply the compensation weight to a subcarrier signal input from the subcarrier demapper 405 to output a signal corresponding to the target frequency response in which the droop phenomenon in the current frequency response of the PRACH decimation filter 402 may be mitigated and/or compensated for. The PRACH filter compensator 415 having a configuration of FIG. 5 may compensate a frequency response characteristic such that a current frequency response (e.g., a first frequency response) of the PRACH decimation filter 402 may approximate a target frequency response (e.g., a second frequency response) when a PRACH preamble is received.

An example operation of the compensation weight calculator 501 included in the PRACH filter compensator is described with reference to the following equations.

$$w [ k ] = \frac{{f}_{target} ( k )}{{f}_{fresp} ( k )} , k = 0 \sim {L}_{RA} - 1 \qquad [ Equation 1 ]$$

Referring to Equation 1, f_{fresp} (k) may represent a current frequency response of the PRACH decimation filter 402, f_{target}(k) may represent a target frequency response for receiving a PRACH preamble, L_{RA} may represent the length of a preamble sequence used for the PRACH preamble. Since f_{fresp}(k) in Equation 1 may generally have a linear phase and may be compensated by a delay in the time domain, Equation 1 may be changed to Equation 2 considering only magnitude.

$$w [ k ] = \frac{\vert {f}_{target} ( k ) \vert}{\vert {f}_{fresp} ( k ) \vert} , k = 0 \sim {L}_{RA} - 1 \qquad [ Equation 2 ]$$

Assuming that the PRACH decimation filter 402 is the CIC decimation filter 300, the current frequency response of the PRACH decimation filter 402 may be represented by an equation similar to Equation 3.

$${f}_{fresp} [ k ] = {{e}^{- j π N ( M - \frac{1}{R} )} ( \frac{sin ( \frac{π M ( k - {k}_{off} )}{{N}_{fft}} )}{sin ( \frac{π ( k - {k}_{off} )}{R \cdot {N}_{fft}} )} )}^{N} \qquad [ Equation 3 ]$$

Referring to Equation 3, M may represent a delay of the comb filter 320 in the CIC decimation filter 300 of FIG. 3, which may usually be 1 or 2, R may represent a decimation factor, N may represent the number of stages of the integrator filter 310 and the comb filter 320, k_{off} may represent a subcarrier position corresponding to a DC subcarrier after a received signal of a base station passes through the frequency shifter 401, and the subcarrier position may have a value close (e.g., similar) to ┌L_{RA}/2┐, N_{fft} may represent an FFT size used for receiving the PRACH preamble after decimation through the PRACH decimation filter 402. Under the assumption in Equation 2, to potentially reduce complexity, subcarriers may be divided into numseg segments, and a representative weight wᵣₑₚ[si], which may be the average of weights for the subcarrier segments, may be represented by Equation 4, where segsize may be the size of a subcarrier segment. In an embodiment, the compensation weight calculator 501 may calculate, obtain, and/or estimate a weight value w[k] according to Equation 4, and may apply the calculated, obtained, and/or estimated weight to the frequency response corrector 502 to compensate the current frequency response of the PRACH decimation filter 402 to the target frequency response.

$$w [ k ] = {w}_{rep} [ si ] for k = 0 \sim {L}_{RA} - 1 , si = ⌊ ( k + {s}_{off} ) / segsize ⌋ \qquad [ Equation 4 ]$$

$$\begin{matrix}{w}_{rep} [ si ] = \frac{\frac{1}{segsize - a} {\sum }_{segm 0 = a}^{segsize - 1} \vert {f}_{target} ( si * segzise + segm 0 - {s}_{off} ) \vert}{\frac{1}{segsize - a} {\sum }_{segm 0 = a}^{segsize - 1} \vert {f}_{fresp} ( si * segzise + segm 0 - {s}_{off} ) \vert} \\ a = \{ \begin{matrix}{s}_{off} & for si == 0 , & si = 0 \sim numseg - 1 \\ 0 & otherwise & \end{matrix} \\ segsize = ⌈ \frac{{L}_{RA}}{numseg} ⌉ , {s}_{off} = ⌈ ( numseg \cdot segsize - {L}_{RA} ) / 2 ⌉\end{matrix}$$

The magnitude of the PRACH decimation filter 402 may generally have a symmetric characteristic, and thus may be maintained to be symmetric considering s_{off} corresponding to an offset in Equation 4. Another example of the method for reducing complexity of the compensation weight calculator 501 may include a method of dividing subcarriers into numseg segments as in Equation 5 and applying linear interpolation to two representative values wᵣₑₚ[si+1] and wᵣₑₚ[si] from among weights for the subcarrier segments. In an embodiment, the method for applying the linear interpolation may be, for example, a method for linearly calculating, obtaining, and/or estimating a compensation weight w[k] positioned between representative weights wᵣₑₚ[si+1] and wᵣₑₚ[si] according to Equation 5 when the representative weights wᵣₑₚ[si+1] and wᵣₑₚ[si] of two points are given.

In an embodiment, the compensation weight calculator 501 may calculate and/or obtain the weight value w[k] according to Equation 5, and may apply the calculated and/or obtained weight to the frequency response corrector 502 to compensate the current frequency response of the PRACH decimation filter 402 to the target frequency response.

$$w [ k ] = \frac{{w}_{rep} [ si + 1 ] - {w}_{rep} [ si ]}{segsize} segm 1 + {w}_{rep} [ si ] for k = 0 \sim {L}_{RA} - 1 \qquad [ Equation 5 ]$$

$$\begin{matrix}si = ⌊ \frac{k + {s}_{off}}{segsize} ⌋ , segm 1 = k + {s}_{off} - si * segsize \\ {w}_{rep} [ si ] = \frac{\vert {f}_{target} ( si * segzise - {s}_{off} ) \vert}{\vert {f}_{fresp} ( si * segzise - {s}_{off} ) \vert} for si = 0 \sim numseg \\ segsize = ⌊ \frac{{L}_{RA}}{numseg} ⌋ , {s}_{off} = ⌈ \frac{numseg \cdot segsize - {L}_{RA}}{2} ⌉\end{matrix}$$

Referring to Equation 5, |f_{target}(m) l and |f_{fresp}(m) l may represent the magnitude of the target frequency response for receiving the PRACH preamble and the magnitude of the current frequency response of the PRACH decimation filter 402, respectively, and the value of m may have a range of m=−s_{off}~numseg*segsize−s_{off}. In Equation 5, w[k] may represent a compensation weight for compensating the current frequency response of the PRACH decimation filter 402 to the target frequency response, wᵣₑₚ[si] may represent a representative weight for each subcarrier segment, si may represent the index of a subcarrier segment, L_{RA} may represent the length of a PRACH preamble sequence, numseg may represent the segment number of subcarrier segments, and segsize may represent the size of subcarrier segments.

To apply the linear interpolation, representative weights for calculating, obtaining, and/or estimating the compensation weight w[k] in Equation 5 may include a first representative weight wᵣₑₚ[si+1] and a second representative weight wᵣₑₚ[si], and the first index si+1 of the first representative weight wᵣₑₚ[si+1] may be a value of the second index si of the second representative weight wᵣₑₚ[si] plus one (1). The compensation weight w[k] may be obtained by adding the second representative weight wᵣₑₚ[si] to a value of a first value ((wᵣₑₚ[Si+1]−wᵣₑₚ[si])/segsize) based on the first representative weight wᵣₑ,[si+1] and the second representative weight wᵣₑₚ[si] multiplied by a ratio value segm1 based on the index k of the compensation weight w[k]. The first value may be a value obtained by dividing a value of the first representative weight wᵣₑ, [si+1] minus the second representative weight wᵣₑₚ[si] by the segment size segsize of the subcarrier segments.

In an embodiment, the compensation weight calculator 501 may calculate, obtain, and/or estimate a compensation weight for mitigating and/or compensating for the droop phenomenon by using the method of Equation 4 or Equation 5. The frequency response corrector 502 to which the weight value is applied may operate according to an equation similar to Equation 6. For example, the frequency response corrector 502 may operate to multiply a subcarrier signal yₐ[k] input from the subcarrier demapper 405 by the weight w[k] and to output a subcarrier signal y_{comp,a}[k] with a frequency characteristic compensated.

$${y}_{comp , a} [ k ] = {y}_{a} [ k ] \cdot w [ k ] , k = 0 \sim L - 1 \qquad [ Equation 6 ]$$

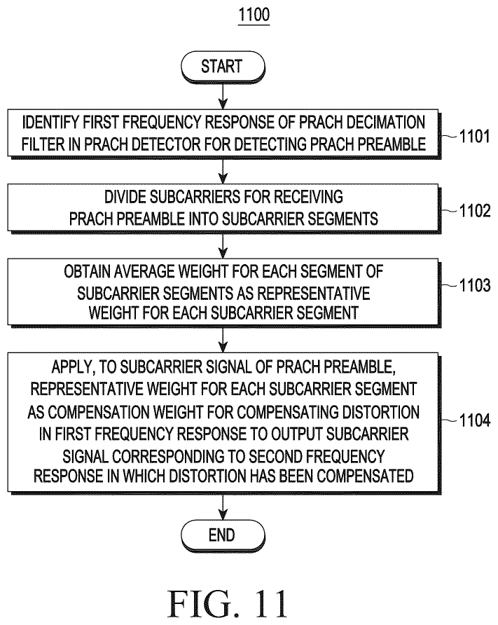

FIG. 11 illustrates an example of a method for compensating distortion in a frequency response of a PRACH decimation filter for detecting a PRACH preamble in a wireless communication system according to an embodiment of the disclosure. The method 1100 of FIG. 11 may be applied to a base station that may calculate, obtain, and/or estimate a compensation weight for mitigating and/or compensating for a droop phenomenon in a frequency response of a PRACH decimation filter by using the method of Equation 4 described above when receiving a PRACH preamble from a UE.

Referring to FIG. 11, in operation 1101, the base station may identify a first frequency response of the PRACH decimation filter 402 in a PRACH detector for detecting a PRACH preamble. In operation 1102, the PRACH filter compensator 415 of the base station having identified the first frequency response may divide subcarriers for receiving the PRACH preamble into subcarrier segments. In operation 1103, the PRACH filter compensator 415 of the base station may obtain an average weight for each segment of the subcarrier segments as a representative weight per subcarrier segment. In operation 1104, the base station may apply the representative weight per subcarrier segment, which may be a compensation weight for compensating distortion in the first frequency response, to a subcarrier signal of the PRACH preamble through the PRACH filter compensator 415, thereby outputting a subcarrier signal corresponding to a second frequency response in which the distortion is compensated.

In the method 1100 of FIG. 11, the base station may apply the compensation weight to the subcarrier signal of the PRACH preamble in the frequency domain subsequent to performing an FFT on a time-domain signal of the PRACH preamble.

In the method 1100 of FIG. 11, the compensation weight may be defined as the ratio of the magnitude of the first frequency response to the magnitude of the second frequency response, and the second frequency response may correspond to a target frequency response for compensating the distortion generated by the first frequency response.

In operation 1103 of FIG. 11, the base station may calculate the average weight for each subcarrier segment, based on the segment size and number of the subcarrier segments and the sequence length of the PRACH preamble, for example, as in Equation 4.

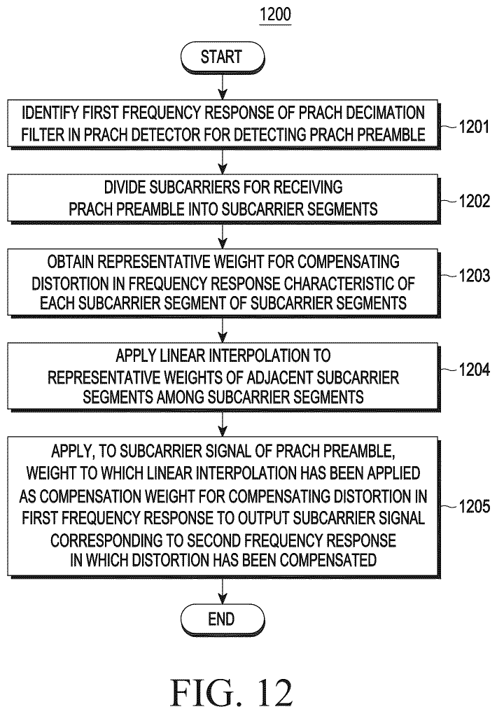

FIG. 12 illustrates an example of a method for compensating distortion in a frequency response of a PRACH decimation filter for detecting a PRACH preamble in a wireless communication system according to an embodiment of the disclosure. The method 1200 of FIG. 12 may be applied to a base station that may calculate, obtain, and/or estimate a compensation weight for mitigating and/or compensating for a droop phenomenon in a frequency response of a PRACH decimation filter by using the method of Equation 5 described above when receiving a PRACH preamble from a UE.

Referring to FIG. 12, in operation 1201, the base station may identify a first frequency response of the PRACH decimation filter 402 in a PRACH detector for detecting a PRACH preamble. In operation 1202, the PRACH filter compensator 415 of the base station having identified the first frequency response may divide subcarriers for receiving the PRACH preamble into subcarrier segments. In operation 1203, the PRACH filter compensator 415 of the base station may obtain a representative weight for compensating distortion in a per-subcarrier segment frequency response characteristic of the subcarrier segments. In operation 1204, the PRACH filter compensator 415 of the base station may apply linear interpolation with respect to the representative weights of adjacent subcarrier segments among the subcarrier segments. In operation 1205, the base station may apply a linear interpolation-applied weight, which is a compensation weight for compensating distortion in the first frequency response, to a subcarrier signal of the PRACH preamble through the PRACH filter compensator 415, thereby outputting a subcarrier signal corresponding to a second frequency response in which the distortion is compensated.

In the method 1200 of FIG. 12, the base station may apply the compensation weight to the subcarrier signal of the PRACH preamble in the frequency domain after performing an FFT on a time-domain signal of the PRACH preamble.

In the method 1200 of FIG. 12, the compensation weight may be defined as the ratio of the magnitude of the first frequency response to the magnitude of the second frequency response, and the second frequency response may correspond to a target frequency response for compensating the distortion generated by the first frequency response.

In operation 1203 of FIG. 12, the base station may calculate the representative weight per subcarrier segment, based on the segment size and number of the subcarrier segments and the sequence length of the PRACH preamble.

In the method 1200 of FIG. 12, the representative weights may include a first representative weight and a second representative weight having adjacent indexes, and the base station may obtain the compensation weight by a linear interpolation operation based on the first representative weight and the second representative weight, for example, as in the method of Equation 5.

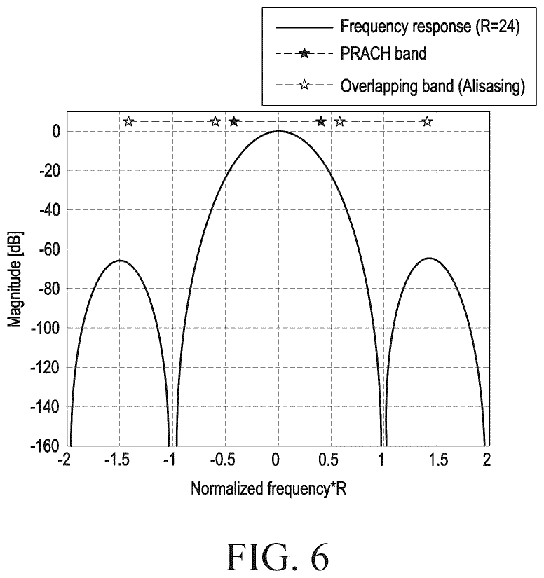

FIG. 6 illustrates an example of a frequency response characteristic of a PRACH decimation filter for PRACH preamble format 0 in a wireless communication system.

The example of FIG. 6 may assume a PRACH preamble format 0 (e.g., RASCS=1.25 kHz) and M=1/N=5/R=24 in an LTE system where number of uplink resource blocks (UL RBs)=100 RBs and UL SCS=15 kHz. A minimum value of 2ⁿ that may be greater than a preamble sequence length of L_{RA}=839 may be 1024. In the LTE system where a number of UL RBs=100 RBs and UL SCS=15 kHz, since a sample rate may be 30.72 MHz, the number of preamble symbols may be calculated to be 24576 Tₛ. When a CIC filter with M=1/N=5 is used as the PRACH decimation filter, a frequency response characteristic where a decimation factor R=24 is as shown in FIG. 6. As used herein, M may be a delay of a comb filter, and may have a value of one (1) or two (2), and N may represent the number of stages of an integrator filter and the comb filter. As shown in FIG. 6, the gain of a tone positioned at the end of a PRACH band may be about −12.7 dB different from that of a tone positioned at the center.

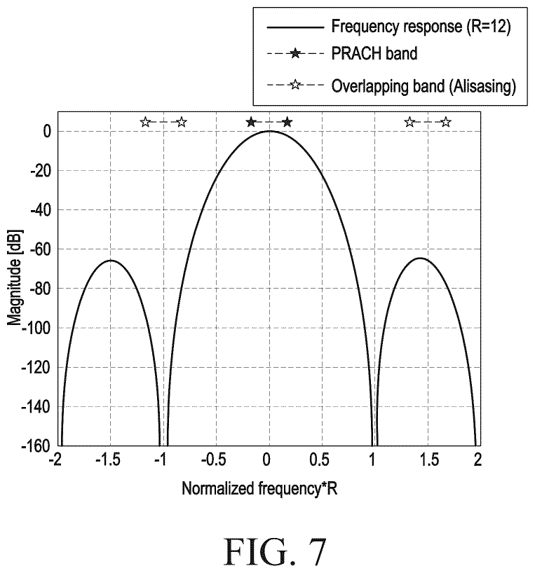

FIG. 7 illustrates an example of a frequency response characteristic of a PRACH decimation filter for PRACH preamble format 0 in a wireless communication system.

The example of FIG. 7 may assume a PRACH preamble format 0 (RASCS=1.25 kHz) and M=1/N=5/R=12 in an LTE system where number of uplink resource blocks (UL RBs)=100 RBs and UL SCS=15 kHz. Assuming that decimation factor R=12, when a CIC filter with M=1/N=5 is used as the PRACH decimation filter, a frequency response characteristic where decimation factor R=12 may be as shown in FIG. 7. FIG. 7 illustrates that the gain of a tone positioned at the end of a PRACH band is about −3.01 dB different from that of a tone positioned at the center.

As in the example of FIG. 6, when the decimation factor=24, 24576 Tₛ is reduced by 1/24, the number of samples after passing through the decimation filter is 1024, and a 1024 FFT may be used. However, as in the example of FIG. 7, when decimation factor=12, the FFT size may be 2048, thus increasing FFT complexity. The CIC filter with decimation factor=12 may have an SNR loss of about 0 dB due to the droop phenomenon in the frequency response, while the CIC filter with decimation factor=24 may have an SNR loss of about 0.55 dB.

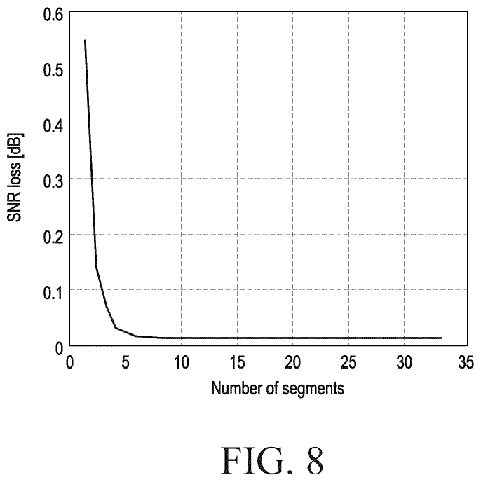

In an embodiment, when a PRACH filter compensator as in the example of FIG. 4 is applied, the magnitude |f_{target}(k)| of a target frequency response for receiving the PRACH preamble may be assumed to be an ideal frequency response of one (1) for performance evaluation. In a case of a decimation factor=24, when a frequency response is flattened through Equation 2, SNR loss in detection of the PRACH preamble may be close to 0 dB. FIG. 8 illustrates an example of SNR loss reduced according to the number of subcarrier segments in a PRACH filter compensator for PRACH preamble format 0 in a wireless communication system, according to an embodiment of the present disclosure. When numseg subcarrier segments are approximated by linear interpolation in the method of Equation 5, an SNR loss of 0.01 dB or less may be observed when numseg=8 or more as in the example of FIG. 8. That is, in an embodiment, when the number of subcarrier segments numseg is 8 or more, SNR loss may be close to 0 dB.

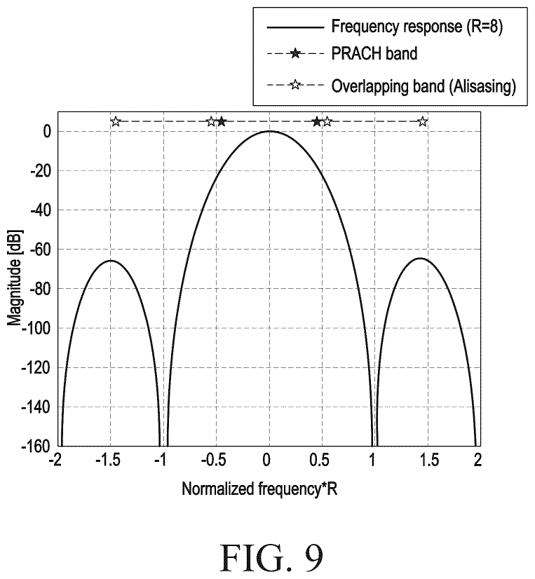

FIG. 9 illustrates an example of a compensated frequency response characteristic of a PRACH decimation filter for a PRACH preamble format with, for example, L_{RA}=479 when a PRACH filter compensator is used in a wireless communication system, according to an embodiment of the present disclosure.

The example of FIG. 9 may assume that the number of uplink resource blocks (UL RBs)=273 RBs, UL SCS=30 kHz (e.g., Sample rate=122.88 MHz), and a PRACH preamble format with a preamble sequence length L_{RA}=479 (RASCS=30 kHz). FIG. 9 illustrates an example of a frequency response characteristic when a CIC filter is used as a PRACH decimation filter with decimation factor=8 (to use FFT=512). FIG. 9 shows that the gain of a tone positioned at the end of a PRACH band is about −16.6 dB different from that of a tone positioned at the center. The CIC filter with decimation factor=8 may allow an SNR loss of about 0.83 dB to arise due to a droop phenomenon. In a case of decimation factor=8, when a frequency response is flattened by the method of Equation 2, SNR loss in detection of a PRACH preamble may be relatively small and may converge to 0.06 dB or less.

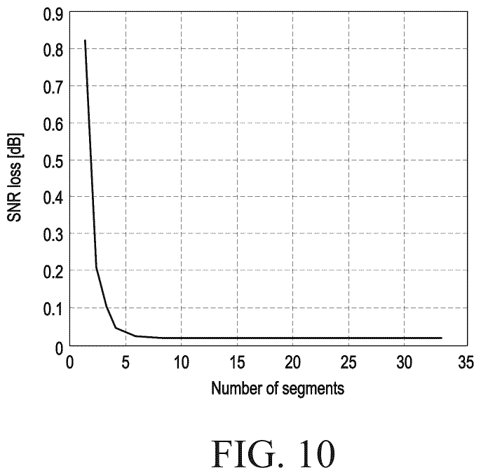

FIG. 10 illustrates an example of SNR loss according to the number of subcarrier segments in a PRACH filter compensator for a PRACH preamble format with, for example, L_{RA}=479 in a wireless communication system, according to an embodiment of the present disclosure. When numseg subcarrier segments are approximated by linear interpolation in the method of Equation 5, an SNR loss of 0.07 dB or less may be observed for the PRACH preamble format with a preamble sequence length of L_{RA}=479 when numseg=10 in the example of FIG. 10. That is, in FIG. 10, when the number of subcarrier segments numseg is 10 or more, SNR loss may be close to 0 dB.

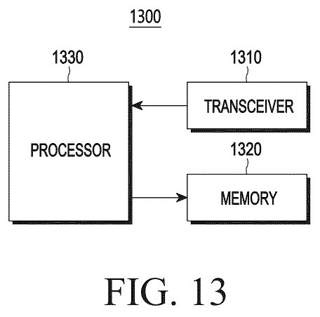

FIG. 13 illustrates an example of a structure of a communication device in a wireless communication system, according to an embodiment of the present disclosure. The embodiments of the disclosure may be applied to a base station 1300 in FIG. 13.

The base station 1300 in FIG. 13 may include a processor 1330, a transceiver 1310, and memory 1320. The processor 1330, the transceiver 1310, and the memory 1320 in FIG. 13 may be operated according to at least one of the embodiments described with reference to FIGS. 4 to 12. However, components of the base station are not limited to the above-described example. For example, the base station may include a larger and/or smaller number of components than the above-described components. In addition, the processor 1330, the transceiver 1310, and the memory 1320 may be implemented in the form of a single chip. The transceiver 1310 may refer to a base station receiver and a base station transmitter as a whole, and may transmit and/or receive signals with UEs and/or other base stations. The transmitted and/or received signals may include at least one of control information and/or data. To this end, the transceiver 1310 may include wired and/or wireless transceivers, and may include various components for transmitting and/or receiving signals. The transceiver 1310 may receive signals, output the same to the processor 1330, and/or transmit signals output from the processor 1330.

In addition, the transceiver 1310 may receive signals from UEs through a network, output same to the processor 1330, and/or transmit signals, output from the processor 1330, to the UEs. The memory 1320 may store programs and/or data necessary for the operation of the base station according to at least one of the embodiments described with reference to FIGS. 4 to 12. Also, the memory 1320 may store instructions that, when executed individually or collectively by one or more processors, may cause the base station 1300 to perform operations. In addition, the memory 1320 may store control information or data included in signals acquired by the base station 1300. The memory 1320 may include storage media such as, but not limited to, a read-only memory (ROM), a random-access memory (RAM), a hard disk, a compact-disc ROM (CD-ROM), a digital versatile disc (DVD), and/or a combination of storage media. Furthermore, the processor 1330 may be a single processing unit or multiple processing units, either of which may include multiple computing units. The processor 1330 may be implemented by one or more processors, a microcomputer, a microcontroller, a digital signal processor (DSP), a central processing unit (CPU), a state machine, processing circuitry, and/or any other device for operating signals, based on operation instructions. Also, the processor 1330 may be configured to retrieve and/or execute computer-readable instructions and/or data stored in the memory 1320. The processor 1330 may control a series of processes for compensating, by the base station 1300, distortion occurring in a frequency response of a PRACH decimation filter for detection of a PRACH preamble according to at least one of the embodiments described with reference to FIGS. 4 to 12.

In an embodiment, a base station 1300 in a wireless communication system may include a transceiver 1310, one or more processors 1330 including processing circuitry, and memory 1320 storing instructions, wherein the instructions may, when individually or collectively executed by the one or more processors 1330, cause the base station 1300 to receive a signal including a physical random access channel (PRACH) preamble from a UE through the transceiver 1310, identify a first frequency response of a PRACH decimation filter 402 in a PRACH detector for detecting the PRACH preamble, divide subcarriers for receiving the PRACH preamble into subcarrier segments, obtain a representative weight for each subcarrier segment for compensating distortion in a frequency response characteristic of each segment of the subcarrier segments, apply linear interpolation to representative weights of adjacent subcarrier segments among the subcarrier segments, and apply, to a subcarrier signal of the PRACH preamble, a weight to which the linear interpolation has been applied as a compensation weight for compensating distortion in the first frequency response to output a subcarrier signal corresponding to a second frequency response in which the distortion has been compensated.

In an embodiment, a base station 1300 in a wireless communication system may include a transceiver 1310, one or more processors 1330 including processing circuitry, and memory 1320 storing instructions, wherein the instructions may, when individually or collectively executed by the one or more processors 1330, cause the base station 1300 to receive a signal including a physical random access channel (PRACH) preamble from a UE through the transceiver 1310, identify a first frequency response of a PRACH decimation filter 402 in a PRACH detector for detecting the PRACH preamble, divide subcarriers for receiving the PRACH preamble into subcarrier segments, obtain an average weight for each segment of the subcarrier segments as a representative weight for each subcarrier segment, and apply, to a subcarrier signal of the PRACH preamble, the representative weight for each subcarrier segment as a compensation weight for compensating distortion in the first frequency response to output a subcarrier signal corresponding to a second frequency response in which the distortion has been compensated.

Methods disclosed in the claims and/or methods according to the embodiments described in the specification of the present disclosure may be implemented by hardware, software, or a combination of hardware and software.

When the methods are implemented by software, a computer-readable storage medium for storing one or more programs (e.g., software modules) may be provided. The one or more programs stored in the computer-readable storage medium may be configured for execution by one or more processors within the electronic device. The at least one program may include instructions that may cause the base station 1300 to perform the methods according to various embodiments of the present disclosure as defined by the appended claims and/or described herein.

These programs (e.g., software modules and/or software) may be stored in non-volatile memories including, but not limited to, a random access memory (RAM), a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively or additionally, any combination of some or all of them may form a memory in which the program is stored. In addition, a plurality of such memories may be included in the electronic device.

Furthermore, the programs may be stored in an attachable storage device which may access the electronic device through communication networks such as, but not limited to, the internet, intranet, local area network (LAN), wide-area LAN (WLAN), storage area network (SAN), and/or a combination thereof. Such a storage device may access the based station 1300 via an external port. Also, a separate storage device on the communication network may access a portable electronic device.

In the above-described embodiments of the present disclosure, an element included in the disclosure is expressed in the singular or the plural according to presented detailed embodiments. However, the singular form or plural form may be selected appropriately to the presented situation for the convenience of description, and the disclosure is not limited by elements expressed in the singular or the plural. Therefore, either an element expressed in the plural may also include a single element or an element expressed in the singular may also include multiple elements.

Although embodiments have been described in the detailed description of the disclosure, it is to be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method performed by a base station in a wireless communication system, the method comprising:
receiving, from a user equipment (UE), a physical random access channel (PRACH) preamble;
detecting the received PRACH preamble by identifying a first frequency response of a PRACH decimation filter in a PRACH detector;
dividing subcarriers for receiving the PRACH preamble into subcarrier segments;
obtaining a representative weight for each subcarrier segment of the subcarrier segments;
applying linear interpolation to representative weights of adjacent subcarrier segments from among the subcarrier segments;
compensating for distortion in the first frequency response of each segment of the subcarrier segments by applying, to a first subcarrier signal of the PRACH preamble, a weight to which the linear interpolation has been applied as a compensation weight; and
outputting a second subcarrier signal corresponding to a second frequency response in which the distortion has been compensated.

2. The method of claim 1, wherein the applying of the compensation weight comprises:
performing a fast Fourier transform (FFT) on a time-domain signal of the PRACH preamble to obtain a frequency-domain signal of the PRACH preamble; and
applying the compensation weight to a subcarrier signal of the frequency-domain signal of the PRACH preamble.

3. The method of claim 1, further comprising:
obtaining the compensation weight by dividing a first magnitude of the first frequency response by a second magnitude of the second frequency response,
wherein the second frequency response corresponds to a target frequency response for compensating the distortion arising from the first frequency response.

4. The method of claim 1, wherein the obtaining of the representative weight comprises:
calculating the representative weight for each subcarrier segment, based on a segment size of the subcarrier segments, a segment number of the subcarrier segments, and a sequence length of the PRACH preamble.

5. The method of claim 1, wherein the representative weights comprise a first representative weight and a second representative weight having adjacent indexes, and
wherein the method further comprises obtaining the compensation weight by performing a linear interpolation operation based on the first representative weight and the second representative weight.

6. The method of claim 4, wherein the representative weights comprise a first representative weight and a second representative weight,
wherein a first index of the first representative weight comprises a value of a second index of the second representative weight plus one (1),
wherein the method further comprises:
obtaining a first value by dividing a value of the first representative weight minus the second representative weight by the segment size of the subcarrier segments;
determining an index of the compensation weight based on the sequence length of the PRACH preamble;
obtaining a second value by multiplying the first value by a ratio value based on the index of the compensation weight; and
obtaining the compensation weight by adding the second representative weight to the second value, and
wherein the applying of the linear interpolation comprises applying the linear interpolation to the representative weights of the adjacent subcarrier segments from among the subcarrier segments based on the first representative weight and the second representative weight.

7. Abase station in a wireless communication system, the base station comprising:
a transceiver;
one or more processors comprising processing circuitry; and
memory storing instructions,
wherein the instructions, when executed by the one or more processors individually or collectively, cause the base station to:
receive, from a user equipment (UE) through the transceiver, a signal comprising a physical random access channel (PRACH) preamble;
detect the received PRACH preamble by identifying a first frequency response of a PRACH decimation filter in a PRACH detector;
divide subcarriers for receiving the PRACH preamble into subcarrier segments;
obtain a representative weight for each subcarrier segment of the subcarrier segments;
apply linear interpolation to representative weights of adjacent subcarrier segments from among the subcarrier segments;
compensate for distortion in the first frequency response of each segment of the subcarrier segments by applying, to a first subcarrier signal of the PRACH preamble, a weight to which the linear interpolation has been applied as a compensation weight; and
output a second subcarrier signal corresponding to a second frequency response in which the distortion has been compensated.

8. The base station of claim 7, wherein the instructions, when executed by the one or more processors individually or collectively, further cause the base station to:
perform a fast Fourier transform (FFT) on a time-domain signal of the PRACH preamble to obtain a frequency-domain signal of the PRACH preamble; and
apply the compensation weight to a subcarrier signal of the frequency-domain signal of the PRACH preamble.

9. The base station of claim 7, wherein the instructions, when executed by the one or more processors individually or collectively, further cause the base station to:
obtain the compensation weight by dividing a first magnitude of the first frequency response by a second magnitude of the second frequency response,
wherein the second frequency response corresponds to a target frequency response for compensating the distortion arising from the first frequency response.

10. The base station of claim 7, wherein the instructions, when executed by the one or more processors individually or collectively, further cause the base station to:
calculate the representative weight for each subcarrier segment, based on a segment size of the subcarrier segments, a segment number of the subcarrier segments, and a sequence length of the PRACH preamble.

11. The base station of claim 7, wherein the representative weights comprise a first representative weight and a second representative weight having adjacent indexes, and
wherein the instructions, when executed by the one or more processors individually or collectively, further cause the base station to:
obtain the compensation weight by performing a linear interpolation operation based on the first representative weight and the second representative weight.

12. The base station of claim 10, wherein the representative weights comprise a first representative weight and a second representative weight,
wherein a first index of the first representative weight comprises a value of a second index of the second representative weight plus one (1),
wherein the instructions, when executed by the one or more processors individually or collectively, further cause the base station to:
obtain a first value by dividing a value of the first representative weight minus the second representative weight by the segment size of the subcarrier segments;
determine an index of the compensation weight based on the sequence length of the PRACH preamble;
obtain a second value by multiplying the first value by a ratio value based on the index of the compensation weight;
obtain the compensation weight by adding the second representative weight to the second value; and
apply the linear interpolation to the representative weights based on the first representative weight and the second representative weight.

13. A method performed by a base station in a wireless communication system, the method comprising:
receiving, from a user equipment (UE), a physical random access channel (PRACH) preamble;
detecting the received PRACH preamble by identifying a first frequency response of a PRACH decimation filter in a PRACH detector;
dividing subcarriers for receiving the PRACH preamble into subcarrier segments;
obtaining an average weight for each segment of the subcarrier segments as a representative weight for each subcarrier segment;
compensating for distortion in the first frequency response of each segment of the subcarrier segments by applying, to a first subcarrier signal of the PRACH preamble, the representative weight as a compensation weight; and
outputting a second subcarrier signal corresponding to a second frequency response in which the distortion has been compensated.

14. The method of claim 13, wherein the applying of the compensation weight comprises:
performing a fast Fourier transform (FFT) on a time-domain signal of the PRACH preamble to obtain a frequency-domain signal of the PRACH preamble; and
applying the compensation weight to a subcarrier signal of the frequency-domain signal of the PRACH preamble.

15. The method of claim 13, further comprising:
obtaining the compensation weight by dividing a first magnitude of the first frequency response by a second magnitude of the second frequency response,
wherein the second frequency response corresponds to a target frequency response for compensating the distortion arising from the first frequency response.

16. The method of claim 13, wherein the obtaining of the representative weight comprises:
calculating the average weight for each subcarrier segment, based on a segment size of the subcarrier segments, a segment number of the subcarrier segments, and a sequence length of the PRACH preamble.

17. Abase station in a wireless communication system, the base station comprising:
a transceiver;
one or more processors comprising processing circuitry; and
memory storing instructions,
wherein the instructions, when executed by the one or more processors individually or collectively, cause the base station to:
receive, from a user equipment (UE) through the transceiver, a signal comprising a physical random access channel (PRACH) preamble;
detect the received PRACH preamble by identifying a first frequency response of a PRACH decimation filter in a PRACH detector;
divide subcarriers for receiving the PRACH preamble into subcarrier segments;
obtain an average weight for each segment of the subcarrier segments as a representative weight for each subcarrier segment;
compensate for distortion in the first frequency response of each segment of the subcarrier segments by applying to a first subcarrier signal of the PRACH preamble, the representative weight for each subcarrier segment as a compensation weight; and
output a second subcarrier signal corresponding to a second frequency response in which the distortion has been compensated.

18. The base station of claim 17, wherein the instructions, when executed by the one or more processors individually or collectively, further cause the base station to:
perform a fast Fourier transform (FFT) on a time-domain signal of the PRACH preamble to obtain a frequency-domain signal of the PRACH preamble; and
apply the compensation weight to a subcarrier signal of the frequency-domain signal of the PRACH preamble.

19. The base station of claim 17, wherein the instructions, when executed by the one or more processors individually or collectively, further cause the base station to:
obtain the compensation weight by dividing a first magnitude of the first frequency response by a second magnitude of the second frequency response,
wherein the second frequency response corresponds to a target frequency response for compensating the distortion arising from the first frequency response.

20. The base station of claim 17, wherein the instructions, when executed by the one or more processors individually or collectively, further cause the base station to:
calculate the average weight for each subcarrier segment, based on a segment size of the subcarrier segments, a segment number of the subcarrier segments, and a sequence length of the PRACH preamble.
